(19) United States
(12) Patent Application Publication
(10) Pub. No.: US 2019/0051945 A1
(43) Pub. Date: Feb. 14, 2019

(54) STACK-TYPE NONAQUEOUS ELECTROLYTE SECONDARY BATTERY

(71) Applicant: Panasonic Intellectual Property Management Co., Ltd., Osaka-shi, Osaka (JP)

(72) Inventors: Daisuke Ito, Hyogo (JP); Yoshitaka Shinyashiki, Hyogo (JP); Kazunori Donoue, Hyogo (JP)

(73) Assignee: Panasonic Intellectual Property Management Co., Ltd., Osaka-shi, Osaka (JP)

(21) Appl. No.: 16/076,789

(22) PCT Filed: Jan. 23, 2017
(86) PCT No.: PCT/JP2017/002093

§ 371 Date: Aug. 9, 2018

(30) Foreign Application Priority Data
Feb. 29, 2016 (JP) 2016-037602

(51) Int. Cl. H01M 10/0585; H01M 2/26

(52) U.S. Cl. CPC H01M 10/0585; H01M 2/266

(57) ABSTRACT

A stack-type nonaqueous electrolyte secondary battery, includes an electrode unit housed in an exterior body. The electrode unit includes a plurality of electrode stacks and an intermediate positive electrode plate. Each of the electrode stacks includes a plurality of positive electrodes, a plurality of negative electrodes. One electrode stack of two of the electrode stacks has the negative electrode disposed adjacent to a first surface of the intermediate positive electrode plate with a corresponding one of the separators interposed therebetween. The other electrode stack has the negative electrode disposed adjacent to a second surface of the intermediate positive electrode plate with a corresponding one of the separators interposed therebetween. The intermediate positive electrode plate body has a smaller area on a side surface in a thickness direction than the positive electrode plate body of each of the electrode stacks.

### TECHNICAL FIELD

The present invention relates to a stack-type nonaqueous electrolyte secondary battery.

### BACKGROUND ART

A stack-type nonaqueous electrolyte secondary battery including an electrode stack formed by stacking multiple pairs of electrodes is known. Examples of such a secondary battery include a lithium-ion battery including multiple positive electrodes, negative electrodes, and separators, and having the positive and negative electrodes alternately stacked with the separators interposed therebetween. In a lithium-ion battery having a stack-type electrode structure, the electrodes are likely to cause, with their expansion and contraction after electric charging and discharging, stress uniformly in the direction in which the electrodes are stacked. Compared to, for example, a winding electrode structure, the stack-type electrode structure reduces distortion of the electrode unit and enhances, for example, uniformization of the cell reaction or an increase of the battery life.

For a lithium-ion battery demanded to have a large size, a large capacity, and high energy density, the stack-type electrode structure facilitates effective use of a surplus space in the exterior body.

PTL 1 discloses a structure of a secondary battery including a plurality of electrode stacks and separators that have their first ends open and that cover the positive electrodes. PTL 1 describes that this structure facilitates convection of an electrolytic solution, which is a liquid nonaqueous electrolyte, and prevents battery degradation.

### CITATION LIST

### Patent Literature

PTL 1: Japanese Published Unexamined Patent Application No. 2012-256610

### SUMMARY OF INVENTION

A secondary battery having a stack-type electrode structure has a problem of reduction of the amount of a nonaqueous electrolyte, such as an electrolytic solution, inside the battery due to reduction of the internal surplus space. The technology described in PTL 1 may enhance convection of the electrolytic solution. However, this technology has little or no effect on the reaction between the electrodes and the electrolytic solution in a long-term cycle, which is a long term charging/discharging cycle, and does not reduce the consumption of the electrolytic solution in the long-term cycle. The above-described structure thus has room for improvement in terms of an increase of the capacity of the retained nonaqueous electrolyte to improve the performance in the long-term cycle. In addition, the structure including arranged multiple electrode stacks, each including multiple positive electrodes and multiple negative electrodes stacked with separators interposed therebetween, and the negative electrodes of adjacent electrode stacks facing each other with a separator interposed therebetween has room for improvement in terms of enhancement of energy density.

A stack-type nonaqueous electrolyte secondary battery according to an aspect of the present disclosure includes an electrode unit housed in an exterior body. The electrode unit includes a plurality of electrode stacks and an intermediate positive electrode plate. Each of the electrode stacks includes a plurality of positive electrodes, a plurality of negative electrodes, and a plurality of separators disposed between the positive electrodes and the negative electrode and at both ends of the electrode stack. Each of the positive electrodes includes a rectangular positive electrode plate body including a positive electrode composite layer, and a positive electrode tab extending from the positive electrode plate body. The intermediate positive electrode plate includes a rectangular intermediate positive electrode plate body including a positive electrode composite layer, and an intermediate positive electrode tab extending from the intermediate positive electrode plate body. One electrode stack of two of the electrode stacks has the negative electrode disposed adjacent to a first surface of the intermediate positive electrode plate with a corresponding one of the separators interposed therebetween. The other electrode stack has the negative electrode disposed adjacent to a second surface of the intermediate positive electrode plate with a corresponding one of the separators interposed therebetween. The intermediate positive electrode plate body has a smaller area on a side surface in a thickness direction than the positive electrode plate body of each of the electrode stacks.

An aspect of the present disclosure achieves a stack-type nonaqueous electrolyte secondary battery having a larger capacity of a retained nonaqueous electrolyte, the battery being capable of improving its performance in a long-term cycle and enhancing the energy density.

### BRIEF DESCRIPTION OF DRAWINGS

FIG. 1 is a perspective view of the external appearance of a stack-type nonaqueous electrolyte secondary battery according to an exemplary embodiment.

FIG. 2 schematically illustrates the section taken along line II-II of FIG. 1.

FIG. 3 schematically illustrates the section taken along line of FIG. 1.

FIG. 4 illustrates an example of the relationship in size between a positive electrode, a negative electrode, a separator, and an intermediate positive electrode plate of the secondary battery.

FIG. 5A is an enlarged view of a portion C in FIG. 3, including more positive electrodes and more negative electrodes stacked than those in FIG. 3.

FIG. 5B corresponds to FIG. 5A, illustrating a portion of the secondary battery, the portion being aligned with the positive electrode terminal in a longitudinal direction.

FIG. 6 is a schematic view of an electrode unit according to another exemplary embodiment having a stacked structure of two electrode stacks and an intermediate positive electrode plate.

FIG. 7 is a schematic view of a connection structure of the positive electrodes and the intermediate positive electrode plate connected with a positive electrode current collector while the two electrode stacks and the intermediate positive electrode plate, illustrated in FIG. 6, are separated from each other.

FIG. 8 is a schematic view of a connection structure of the negative electrodes connected with the negative electrode current collector while the two electrode stacks and the intermediate positive electrode plate, illustrated in FIG. 6, are separated from each other.

FIG. 9, corresponding to FIG. 2, illustrates another exemplary embodiment.

### DESCRIPTION OF EMBODIMENTS

Hereinbelow, a stack-type nonaqueous electrolyte secondary battery according to an exemplary embodiment is described in detail. The drawings that are referred to in the description of embodiments are only schematic, and dimensional ratios between components and other details in the drawings may differ from the actual ones. Specific dimensional ratios and other details are to be determined in consideration of the following description. In the present description, the word “substantially”, for example, substantially the same is intended to include the meaning of substantially regarded as the same, to say nothing of completely the same. The wording “end portion” is intended to include the meaning of an end of an object and the vicinity of the end. The shape, the material, the number, and other properties described in the following description are only exemplary, and may be changed depending on the specification of a secondary battery. The same components are denoted with the same reference numerals, below.

A stack-type nonaqueous electrolyte secondary battery described below is used for, for example, a power supply for driving an electric vehicle or a hybrid car or a stationary electricity storage system provided for shifting peak demand of the publicly distributed electricity. The stationary electricity storage system is used for reducing output fluctuations of power generation, such as solar power generation or wind power generation, or to store electricity at nighttime for use in daytime.

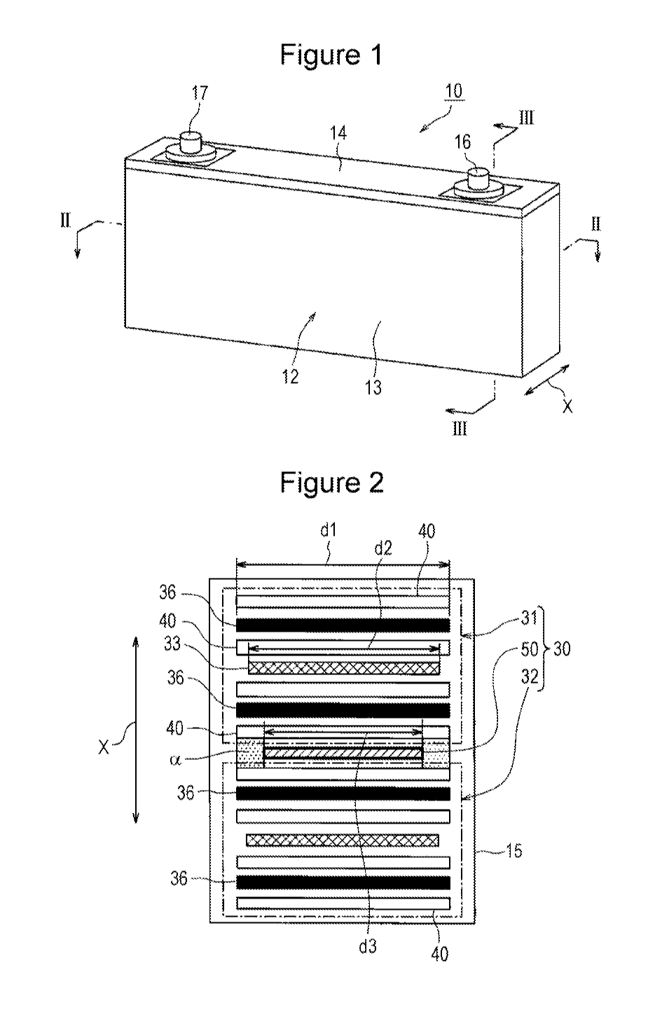

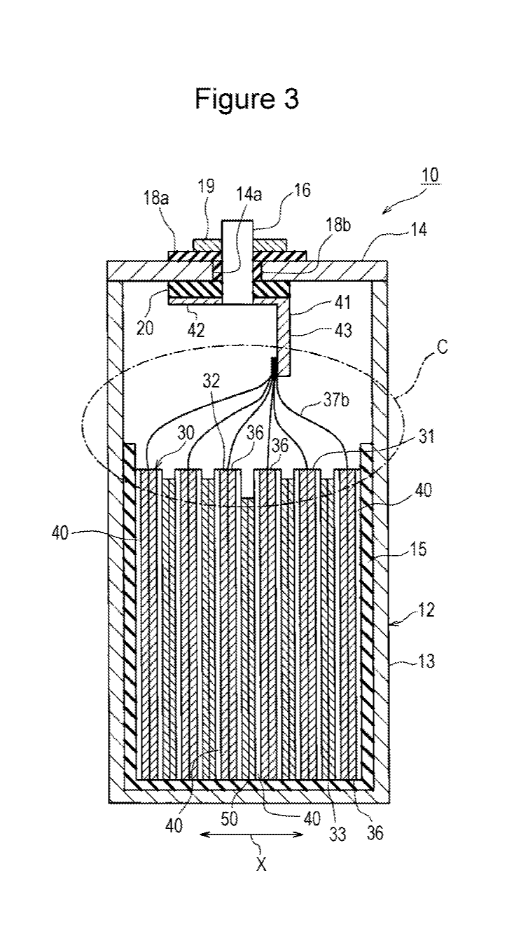

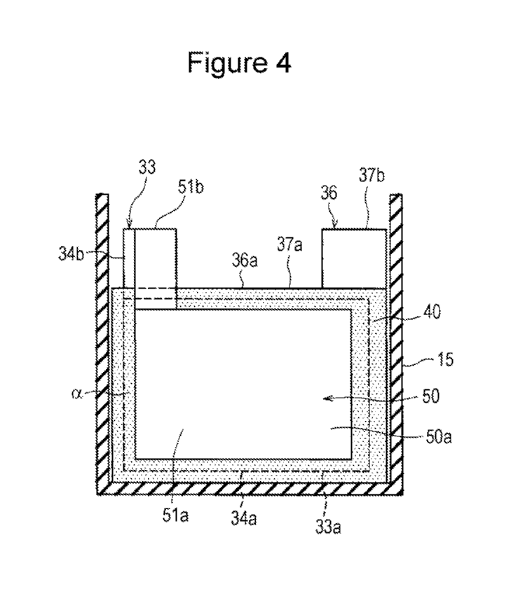

A stack-type nonaqueous electrolyte secondary battery 10 according to an exemplary embodiment is described below in detail, with reference to FIGS. 1 to 5B. The stack-type nonaqueous electrolyte secondary battery 10 is described as a secondary battery 10, below. FIG. 1 is a perspective view of the external appearance of the secondary battery 10. FIG. 2 schematically illustrates the section taken along line II-II of FIG. 1. FIG. 3 schematically illustrates the section taken along line of FIG. 1. For convenience of illustration, the side of a case 12 closer to a cover plate 14 is described as an upper side, and the side of the case 12 away from the cover plate 14 is described as a lower side, below.

The secondary battery 10 includes a case 12, serving as an exterior body, and an electrode unit 30, housed in the case 12 and serving as a power generator. The case 12 houses an electrolytic solution corresponding to a nonaqueous electrolyte, describe below. The case 12 has an upper end portion, on which a negative electrode terminal 16 protrudes from a first end portion (right end portion in FIG. 1) of the upper end portion in the longitudinal direction, and a positive electrode terminal 17 protrudes from a second end portion (left end portion in FIG. 1) of the upper end portion in the longitudinal direction.

The electrode unit 30 includes two electrode stacks 31 and 32, an example of multiple electrode stacks, and an intermediate positive electrode plate 50, interposed between the two electrode stacks 31 and 32. The electrode stacks 31 and 32 and the intermediate positive electrode plate 50 are stacked one on another. The two electrode stacks 31 and 32 are electrically connected in parallel, and housed in the case 12 while being immersed in the electrolytic solution.

Specifically, each of the electrode stacks 31 and 32 has a so-called stacked-type electrode structure formed by stacking multiple positive electrodes 33, multiple negative electrodes 36, and multiple separators 40 disposed between the positive electrodes 33 and the negative electrodes 36 and at both ends of the electrode stack 31 or 32. In FIG. 2, the positive electrodes 33 are drawn with netted quadrangles, the negative electrodes 36 are drawn with solid black quadrangles, and the separators 40 are drawn with blank quadrangles. An intermediate positive electrode plate 50, described below, is drawn with a hatched quadrangle.

The separators 40 are formed of ion-permeable and insulating porous sheets. A preferable example of the secondary battery 10 is a lithium-ion battery.

As illustrated in FIG. 1, the case 12 includes a case body 13, having a substantially box shape, and a cover plate 14, closing the upper end opening of the case body 13. The case body 13 and the cover plate 14 are made of a metal containing, for example, aluminum as a main component. The case body 13 and the cover plate 14 are bonded together by welding.

In the secondary battery 10, the case 12 is insulated from the positive electrodes 33 and the negative electrodes 36, and has an electrically neutral polarity. As illustrated in FIGS. 2, 3, and 4 below, for example, the electrode unit 30 and the electrolytic solution are housed in a holder 15 made of an insulating material. The holder 15 is made of, for example, a resin and has a rectangular parallelepiped box shape having an open upper end.

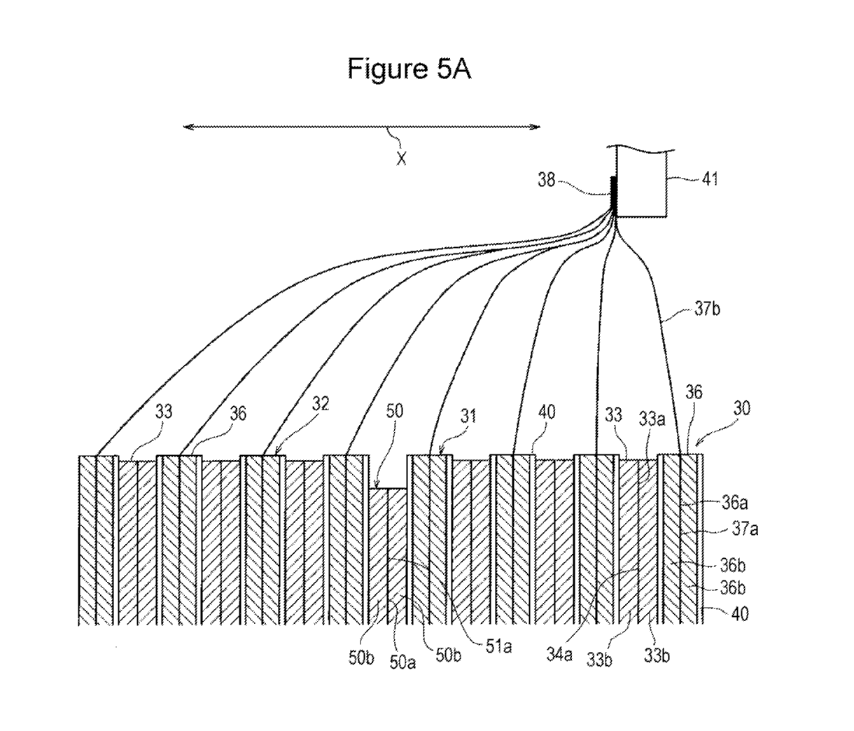

All the positive electrodes 33, the negative electrodes 36, and the separators 40 forming the electrode stacks 31 and 32 of the electrode unit 30 have, for example, a substantially rectangular shape in a plan view. The electrode stacks 31 and 32 formed by staking these have substantially a rectangular parallelepiped shape. As illustrated in FIG. 4, below, each positive electrode 33 includes a positive electrode tab 34b at a second end portion (left end portion of FIG. 4) of the positive electrode 33 in the longitudinal direction (lateral direction of FIG. 4). Each negative electrode 36 includes a negative electrode tab 37b at a first end portion (right end portion of FIG. 4) in the longitudinal direction. In an embodiment, the positive electrode tabs 34b and the negative electrode tabs 37b extend from a first end (upper end in FIG. 4) of the electrode stacks 31 and 32 in the width direction (vertical direction in FIG. 4), perpendicular to the longitudinal direction of the electrode stacks 31 and 32 having a substantially rectangular parallelepiped shape.

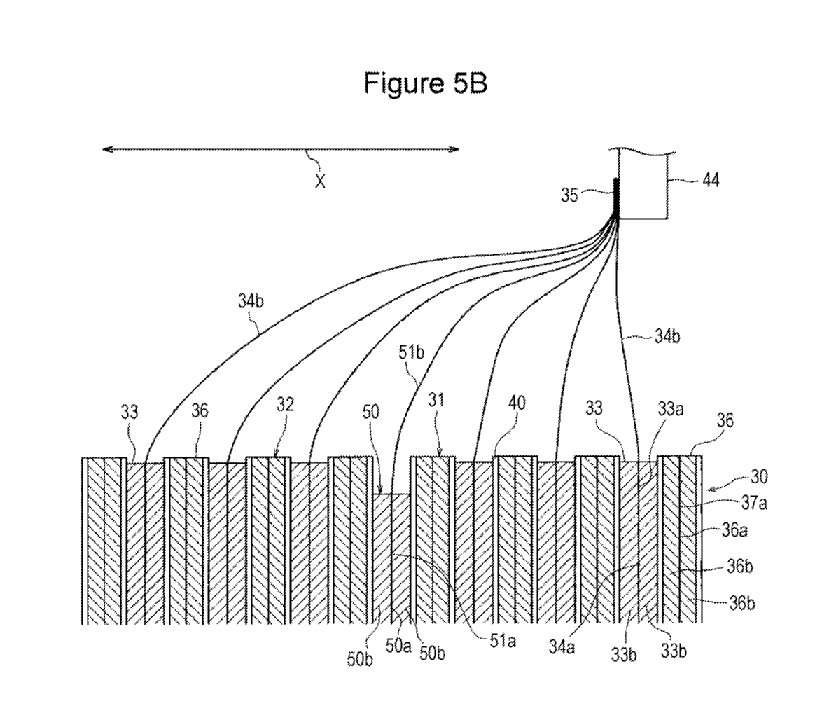

Each of the positive electrodes 33 includes, for example, a positive electrode core 33a (FIGS. 4, 5A, and 5B) and positive electrode composite layers 33b (FIGS. 5A and 5B) on the core 33a. The positive electrode core 33a may be formed of, for example, metal foil stable at positive electrode potentials such as aluminum, or a film having the metal on the surface layers. The positive electrode core 33a includes a rectangular portion formed into a positive electrode plate body 34a combined with positive electrode composite layers 33b, and a positive electrode tab 34b extending from the rectangular portion. Each positive electrode tab 34b is, for example, a protruding portion of the positive electrode core 33a and integrated with the portion forming the positive electrode plate body 34a. The positive electrode composite layers 33b preferably contain, besides the positive electrode active material, an electrically conducting material and a binder, and are disposed on both surfaces of the positive electrode plate body 34a. Each positive electrode 33 is manufactured by, for example, applying, to the positive electrode core 33a, positive electrode composite slurry containing a positive electrode active material and a binder, drying the applied material, and rolling the resultant to form the positive electrode composite layers 33b on both surfaces of the positive electrode core 33a.

A lithium-containing composite oxide is used as an example of the positive electrode active material. The lithium-containing composite oxide is not limited to a particular one, but is preferably a composite oxide corresponding to a general formula Li₁₊ₓMₐO_{2+b} (wherein x+a=1, −0.2<x≤0.2, −0.1≤b≤0.1, and M contains at least one of Ni, Co, Mn, and Al). A preferable example of a composite oxide is a Ni—Co—Mn-based or Ni—Co—Al-based lithium-containing composite oxide.

Each of the negative electrodes 36 includes, for example, a negative electrode core 36a (FIGS. 4, 5A, and 5B), and negative electrode composite layers 36b (FIGS. 5A and 5B) disposed on the core 36a. The negative electrode core 36a may be formed of, for example, metal foil stable at negative electrode potentials such as copper or a film having the metal on the surface layers. The negative electrode core 36a includes a rectangular portion formed into a negative electrode plate body 37a combined with negative electrode composite layers, and a negative electrode tab 37b extending from the rectangular portion. Each negative electrode tab 37b is, for example, a protruding portion of the negative electrode core 36a and integrated with the negative electrode plate body 37a. The negative electrode composite layers 36b preferably contain a binder besides the negative electrode active material. Each negative electrode 36 is manufactured by, for example, applying, to the negative electrode core 36a, negative electrode composite slurry containing a negative electrode active material, a binder, and other materials, drying the applied material, and rolling the resultant to form negative electrode composite layers 36b on both surfaces of the negative electrode core 36a.

Any material that can occlude and discharge lithium ion is usable as the negative electrode active material, typically, graphite is used. Silicon, a silicon compound, or a mixture of these may be used as the negative electrode active material. A silicon compound or the like and a carbon material such as graphite may be used together. A silicon compound or the like can occlude a larger amount of lithium ion than a carbon material such as graphite. Thus, use of these materials as the negative electrode active material can enhance the energy density of the battery. A preferable example of the silicon compound is a silicon oxide expressed by SiOₓ (0.5≤x≤1.5). SiOₓ preferably has its particle surface coated with a conducting coat such as amorphous carbon.

The electrolytic solution is a liquid electrolyte containing a nonaqueous solvent and electrolyte salt solved in the nonaqueous solvent. Examples of the nonaqueous solvent include an ester solvent, an ether solvent, a nitrile solvent, an amide solvent, and a mixture solvent containing two or more of these solvents. The nonaqueous solvent may contain a halogen substitution product formed by replacing at least part of hydrogen in these solvents with halogen atoms such as fluorine. Electrolyte salt is preferably lithium salt.

As in the positive electrodes 33 constituting the electrode stacks 31 and 32, the intermediate positive electrode plate 50 includes, for example, an intermediate positive electrode core 50a (FIG. 4) and an intermediate positive electrode composite layer 50b (FIGS. 5A and 5B) disposed on the core 50a. FIG. 4 omits the illustration of the intermediate positive electrode composite layer. The intermediate positive electrode core 50a includes a rectangular portion forming an intermediate positive electrode plate body 51a in combination with intermediate positive electrode composite layers 50b, and an intermediate positive electrode tab 51b extending from the rectangular portion. The intermediate positive electrode composite layers 50b preferably contain, besides the intermediate positive electrode active material, an electrically conducting material and a binder, and are disposed on both surfaces of the intermediate positive electrode plate body 51a. Specific examples of the intermediate positive electrode core 50a and the intermediate positive electrode composite layers 50b are the same as the case of the positive electrode core 33a and the positive electrode composite layers 33b.

The intermediate positive electrode plate body 51a has a smaller area in the side surfaces in the thickness direction (front and back surfaces of the plane in FIG. 4) than the positive electrode plate bodies 34a of the positive electrodes 33 constituting the electrode stacks 31 and 32.

FIG. 4 illustrates an example of the relationship in size between a positive electrode 33, a negative electrode 36, a separator 40, and an intermediate positive electrode plate 50 of the secondary battery 10. As illustrated in FIG. 4, the rectangular negative electrode plate body 37a constituting each negative electrode 36 is preferably larger than the rectangular positive electrode plate body 34a constituting each positive electrode 33. Each portion of the positive electrode core 33a to which the positive electrode active material layers are applied is preferably sized to be completely covered with each portion of the negative electrode core 36a to which the negative electrode active material layers are applied. Each separator 40 has a rectangular shape with substantially the same shape and area as those of the rectangular shape of the negative electrode plate body 37a viewed in the thickness direction.

On the other hand, the rectangular portions of each intermediate positive electrode plate body 51a, which are the side surfaces in the thickness direction, have a smaller area than the rectangular portions of the positive electrode plate body 34a of each positive electrode 33, which are the side surfaces in the thickness direction. Here, the rectangular portions of the intermediate positive electrode plate body 51a have dimensions, in both the longitudinal direction (lateral direction in FIG. 4) and the width direction (vertical direction in FIG. 4), smaller than the rectangular portions of the positive electrode plate body 34a. In the examples illustrated in FIGS. 2 and 4, d3, d2, and d1 are in descending order (d3<d2<d1), where d1, d2, and d3 respectively denote the length of the negative electrode plate body 37a in the longitudinal direction, the length of the positive electrode plate body 34a in the longitudinal direction, and the length of the intermediate positive electrode plate body 51a in the longitudinal direction.

As illustrated in FIGS. 2 and 3, in the two electrode stacks 31 and 32, the intermediate positive electrode plate 50 is arranged adjacent to the negative electrodes 36 in the electrode stacks 31 and 32 with the separators 40 interposed therebetween. In this state, the intermediate positive electrode plate 50 and the two electrode stacks 31 and 32 are stacked to form the electrode unit 30. In the present description, electrode stacks adjacent to each other with the intermediate positive electrode plate 50 interposed therebetween (on a first surface and a second surface of an intermediate electrode unit) are defined as different electrode stacks.

FIG. 5A is an enlarged view of a portion C in FIG. 3, including more positive electrodes 33 and more negative electrodes 36 stacked than those in FIG. 3. As illustrated in FIGS. 3 and 5A, in the electrode stacks 31 and 32, the negative electrode tabs 37b of the negative electrodes 36 extend from a first end (upper end in FIGS. 3 and 5A) in the width direction (lateral direction) at first end portions (front end portions in the plane of FIGS. 3 and 5A, or right end portions in FIG. 4) of the negative electrodes 36 in the longitudinal direction. The negative electrode tabs 37b are stacked in the electrode stack direction X to be collected to form a tab stack 38. The tab stack 38 is stacked on a first surface of a negative electrode current collector 41 in the thickness direction (left surface in FIGS. 3 and 5A) and joined to the surface by welding.

The electrode unit 30 may be formed by stacking the intermediate positive electrode plate 50 in the middle of stacking the positive electrodes 33, the separators 40, and the negative electrodes 36 in order. Alternatively, the electrode unit 30 may be formed by preparing multiple electrode stacks fixed with, for example, an adhesive or adhesive tape, and by holding the intermediate positive electrode plate 50 between the multiple electrode stacks.

As illustrated in FIG. 3, the negative electrode current collector 41 is made of a metal plate, and has a L-shaped section including an upper end plate portion 42, substantially parallel to a cover plate 14 of the case 12, and a lower end plate portion 43 continuous with and bent perpendicularly to the upper end plate portion 42. The tab stack 38 is joined, by welding, for example, supersonic welding, to a first surface (left surface in FIGS. 3 and 5A) of the negative electrode current collector 41 in the thickness direction, which is the electrode stack direction X, at a lower end portion (lower end portion in FIGS. 3 and 5A) of the lower end plate portion 43 of the negative electrode current collector 41. Thus, the negative electrode tabs 37b extending from the end portions of the multiple negative electrodes 36 are collected and welded onto the negative electrode current collector 41, and the tab stack 38 is thus electrically connected to the negative electrode current collector 41. As described below, the negative electrode current collector 41 is electrically connected to the negative electrode terminal 16.

FIG. 5B corresponds to FIG. 5A, illustrating a portion of the secondary battery 10, the portion being aligned with the positive electrode terminal 17 (FIG. 1) in a longitudinal direction. The positive electrode tabs 34b, which are tabs of the positive electrodes 33 in the electrode stacks 31 and 32, extend from a first end (upper end in FIGS. 3, 4, and 5B) in the width direction (lateral direction) at a second end portion (back side end portion of the plane of FIGS. 3 and 5B or left end portion of FIG. 4) of the positive electrodes 33 in the longitudinal direction. The intermediate positive electrode tab 51b of the intermediate positive electrode plate 50 extends from a first end (upper end in FIGS. 3, 4, and 5B) in the width direction (lateral direction) at a second end portion (back side end portion of the plane of FIGS. 3 and 5B, or left end portion of FIG. 4) of the intermediate positive electrode plate 50 in the longitudinal direction. The multiple positive electrode tabs 34b of the positive electrodes 33 and the intermediate positive electrode tab 51b of the intermediate positive electrode plate 50 are stacked and collected in the electrode stack direction X to form a tab stack 35. The tab stack 35 is stacked on and joined by welding to a first surface (left surface in FIG. 5B) of a positive electrode current collector 44 in the thickness direction.

As in the case of the negative electrode current collector 41 (FIG. 3), the positive electrode current collector 44 also has a L-shaped section. The tab stack 35 to which the positive electrodes 33 are connected is welded, for example, supersonic welding, to a first surface (left surface in FIG. 5B) of the positive electrode current collector 44 in the thickness direction, which is the electrode stack direction X, at a lower end portion of the positive electrode current collector 44. Thus, the multiple positive electrodes 33 and the intermediate positive electrode plate 50 are electrically connected to the positive electrode current collector 44. As described below, the positive electrode current collector 44 is electrically connected to the positive electrode terminal 17 (FIG. 1).

With reference again to FIG. 3, through holes 14a are formed at both end portions of the cover plate 14, disposed at the upper end of the case 12, to allow the negative electrode terminal 16 and the positive electrode terminal 17 (FIG. 1) to extend therethrough. The negative electrode terminal 16 and the positive electrode terminal 17 are fixed to the cover plate 14 while being respectively inserted into the through holes 14a in the cover plate 14 with intermediate members 18a and 18b interposed therebetween. Portions of the negative electrode terminal 16 and the positive electrode terminal 17 protruding upward beyond the cover plate 14 are fixed by, for example, screwing upper coupling members 19. An intermediate member 18a is held between each upper coupling member 19 and the cover plate 14. The intermediate members 18a and 18b may be gaskets. The negative electrode terminal 16 and the cover plate 14 are insulated from each other with an intermediate member serving as a gasket.

The negative electrode terminal 16 has its lower end portion electrically connected to the upper end plate portion 42 of the negative electrode current collector 41. An insulating member 20 made of an insulating material is interposed between the upper end plate portion 42 and the cover plate 14. The positive electrode terminal 17 and the cover plate 14 are also insulated from each other with intermediate members. The positive electrode terminal 17 has its lower end portion electrically connected to an upper end portion of the positive electrode current collector 44 (FIG. 5B). The positive electrode current collector 44 and the cover plate 14 are also separated by an insulating member interposed therebetween, as in the case of the negative electrode current collector 41. Thus, the case 12 is insulated from the positive electrodes 33 and the negative electrodes 36.

One or more circuit breaker systems may be disposed on the negative electrode terminal 16, on the positive electrode terminal 17, or on both. An example usable as the circuit breaker system is a pressure-sensitive circuit breaker system that breaks current in response to a rise of the internal pressure in the battery, which may be installed, for example, on the connection path between the positive electrode current collector and the positive electrode terminal. Other examples usable as the circuit breaker system include a fuse besides the pressure-sensitive circuit breaker system.

As described above, the tab stack 38 of the negative electrode tabs 37b are electrically connected to the negative electrode current collector 41 by welding. Thus, the negative electrodes 36 are electrically connected to the negative electrode terminal 16 with the negative electrode current collector 41.

In addition, the tab stack 35 of the positive electrode tabs 34b and the intermediate positive electrode tab 51b are electrically connected to the positive electrode current collector 44 (FIG. 5B) by welding. The positive electrode current collector 44 is electrically connected to the positive electrode terminal 17 (FIG. 1). Thus, the positive electrodes 33 and the intermediate positive electrode plate 50 are electrically to the positive electrode terminal 17 by the positive electrode current collector 44.

In the electrode unit 30 having the above described structure, outermost electrodes disposed adjacent to the two separators 40 on both ends in the electrode stack direction X, and disposed on both ends in the vertical direction in FIG. 2 or in the lateral direction in FIG. 3 are negative electrodes 36. As in the case of the negative electrodes 36 located in other portions, the negative electrodes 36 located at the outermost may each be formed with a negative electrode core 36a having negative electrode composite layers on both surfaces. This structure enables cost reduction by using common components. Alternatively, the positive electrodes 33 may be disposed as the outermost electrodes. In this case, however, these positive electrodes 33 do not allow positive electrode composite layers to be disposed on the outer surfaces facing the case 12. This structure fails to use, in common, the positive electrodes 33 located at the outermost and the positive electrodes 33 located at other portions and each having positive electrode composite layers on both surfaces of the positive electrode core.

With reference back to FIG. 2, the holder 15 in the case 12 holds the electrolytic solution. An inter-separator holding area α that holds the electrolytic solution is formed in dotted portions in FIG. 2. Across the inter-separator holding area α, the separators 40 of the two electrode stacks 31 and 32 at the ends facing the intermediate positive electrode plate 50 face each other. As illustrated in the dotted portion in FIG. 4, the inter-separator holding area α is an area of the rectangular inner portion corresponding to the shape of the separators 40 from which the portion in which the intermediate positive electrode plate body 51a and the intermediate positive electrode tab 51b overlap is excluded, when viewed in a first thickness direction of the separators 40. The inter-separator holding area α corresponds to a portion in a surplus space between the two electrode stacks 31 and 32 excluding the space occupied by the intermediate positive electrode plate body 51a and the intermediate positive electrode tab 51b. In an embodiment, the intermediate positive electrode plate body 51a has a smaller area on the side surfaces in the thickness direction, than the area of the side surfaces in the thickness direction, of the positive electrode plate body 34a of each of the positive electrodes 33 of the electrode stacks 31 and 32. This structure enables an increase of the inter-separator holding area α. This increase enables an increase of the capacity of the retained electrolytic solution serving as the nonaqueous electrolyte. If the electrolytic solution is consumed in the electrode stacks 31 and 32 in the long-term cycle, the consumed amount may be replenished with the electrolytic solution in the inter-separator holding area α. This structure thus improves the performance in the long-term cycle.

Conceivable as a comparative example is a structure in which two electrode stacks each formed by stacking multiple positive electrodes and multiple negative electrodes with separators interposed therebetween are arranged, and the negative electrodes of the adjacent electrode stacks face each other with separators interposed therebetween. This comparative example does not include an intermediate positive electrode plate between the two electrode stacks. Compared to this comparative example, the embodiment allows the surplus space between the two electrode stacks 31 and 32 to have a battery capacity with the presence of the intermediate positive electrode plate 50. Specifically, compared to the comparative example, the embodiment can utilize charging and discharging of the intermediate positive electrode plate 50 and the negative electrodes 36 on both sides of the intermediate positive electrode plate 50. The structure of the above comparative example usually has a gap of a certain size between the two electrode stacks. Unlike the comparative example, the embodiment includes the intermediate positive electrode plate 50 between the two electrode stacks 31 and 32. This structure is more likely to prevent the thickness of the entire secondary battery in the lamination direction from exceeding the thickness of the intermediate positive electrode plate 50. This structure, improving its charging and discharging performance with the addition of the intermediate positive electrode plate 50, improves the energy density.

The intermediate positive electrode plate body 51a may be smaller than the positive electrode plate body 34a of each positive electrode 33 in only the longitudinal direction or the width direction. For example, the intermediate positive electrode plate body 51a and the positive electrode plate body 34a may have the same length in the longitudinal direction, and the intermediate positive electrode plate body 51a may have its dimension in the width direction smaller than the positive electrode plate body 34a. Alternatively, the intermediate positive electrode plate body 51a and the positive electrode plate body 34a may have the same dimension in the width direction, and the intermediate positive electrode plate body 51a may have its length in the longitudinal direction smaller than the positive electrode plate body 34a. Here, the inter-separator holding area α has smaller dimensions in the longitudinal or width direction than in the structure of FIG. 4. This structure also has a larger inter-separator holding area than in the case of the structure where the intermediate positive electrode plate has the same dimensions as the those of the positive electrodes.

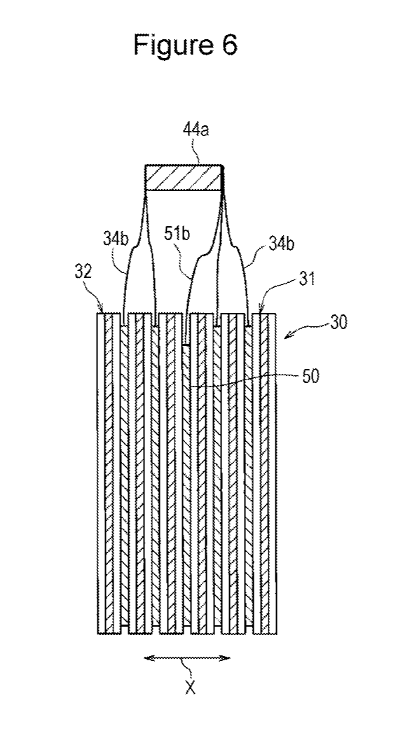

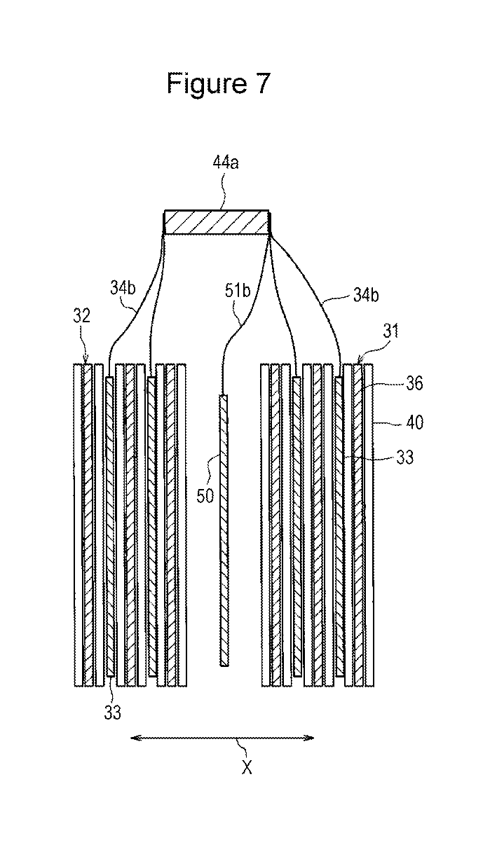

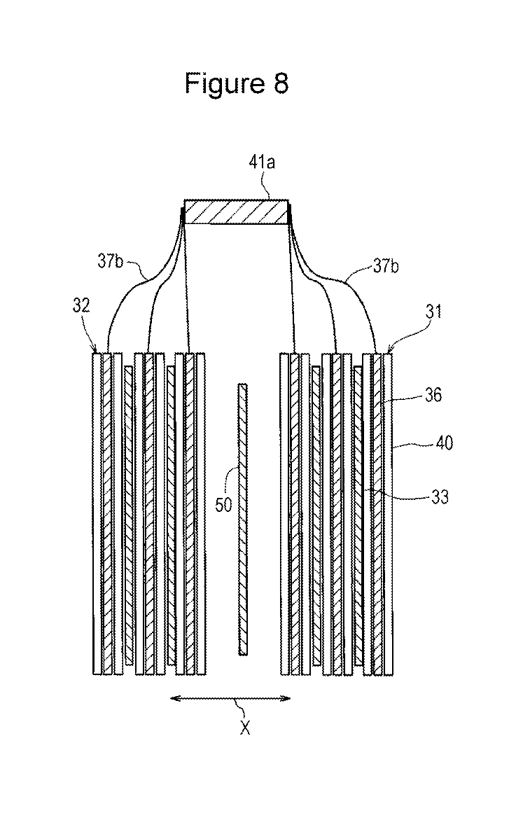

FIG. 6 is a schematic view of the electrode unit 30 according to another exemplary embodiment having a stacked structure in which the two electrode stacks 31 and 32 and the intermediate positive electrode plate 50 are stacked. FIG. 7 is a schematic view of a connection structure of the positive electrodes 33 and the intermediate positive electrode plate 50 connected with a positive electrode current collector 44a while the two electrode stacks 31 and 32 and the intermediate positive electrode plate 50, illustrated in FIG. 6, are separated from each other. FIG. 8 is a schematic view of a connection structure of the negative electrodes 36 connected with a negative electrode current collector 41a while the two electrode stacks 31 and 32 and the intermediate positive electrode plate 50, illustrated in FIG. 6, are separated from each other.

As illustrated in FIGS. 6 to 8, an electrode unit may be assembled by assembling each of the electrode stacks 31 and 32 in advance, and by holding the intermediate positive electrode plate 50 therebetween. Specifically, each electrode stack may be formed by bonding the positive electrodes 33, the negative electrodes 36, and the separators 40 together, or by fixing the outer periphery of each electrode stack with the separator or an adhesive tape. The intermediate positive electrode plate 50 is held between the electrode stacks 31 and 32 thus formed to form the electrode unit 30.

In the structure of FIGS. 1 to 5B, all the positive electrode tabs and the intermediate positive electrode tab are collectively stacked and joined to a first surface of the positive electrode current collector 44 in the electrode stack direction X. In this structure, all the negative electrode tabs are collectively stacked and jointed to a first surface of the negative electrode current collector 41 in the electrode stack direction X.

In another structure of FIGS. 6 to 8, the positive electrode tabs 34b of the two electrode stacks 31 and 32 are separately joined to both side surfaces of the positive electrode current collector 44a in the electrode stack direction X. FIGS. 6 to 8 schematically illustrate the rectangular sections of the positive electrode current collector 44a and the negative electrode current collector 41a. FIGS. 7 and 8 respectively illustrate the positive electrode current collector 44a and the negative electrode current collector 41a longer in the electrode stack direction X, but the actual lengths of the positive electrode current collector 44a and the negative electrode current collector in the electrode stack direction X are smaller, as illustrated in FIG. 6. As in the case of the structure illustrated in FIG. 3, the positive electrode current collector and the negative electrode current collector may be formed of metal plates having L-shaped section.

As illustrated in FIG. 6, the intermediate positive electrode plate 50 is stacked while being held between the two electrode stacks 31 and 32. The positive electrode tabs 34b of one electrode stack 31 (right in FIGS. 6 and 7) of the two electrode stacks 31 and 32 and the intermediate positive electrode tab 51b of the intermediate positive electrode plate 50 are collectively stacked on and welded to a first surface (right surface in FIGS. 6 and 7) of the positive electrode current collector 44a in the electrode stack direction X. The positive electrode tabs 34b of the other one electrode stack 32 (left in FIGS. 6 and 7) of the two electrode stacks 31 and 32 is collectively stacked on and welded to a second surface (left surface in FIGS. 6 and 7) of the positive electrode current collector 44a in the electrode stack direction X.

As illustrated in FIG. 8, the negative electrode tabs 37b of the electrode stack 31 and the negative electrode tabs 37b of the electrode stack 32 are separated from each other and stacked on and welded to the respective side surfaces of the negative electrode current collector 41a in the electrode stack direction X.

In the above structure, the tab stacks of the respective positive and negative electrodes of the electrode stacks 31 and 32 have smaller thickness. This structure facilitates welding performance and is more likely to prevent electric resistance at the tab joined portion from increasing. This structure is more likely to uniform the current-carrying properties through the tabs. Other components and functions are the same as those of the structure in FIGS. 1 to 5B.

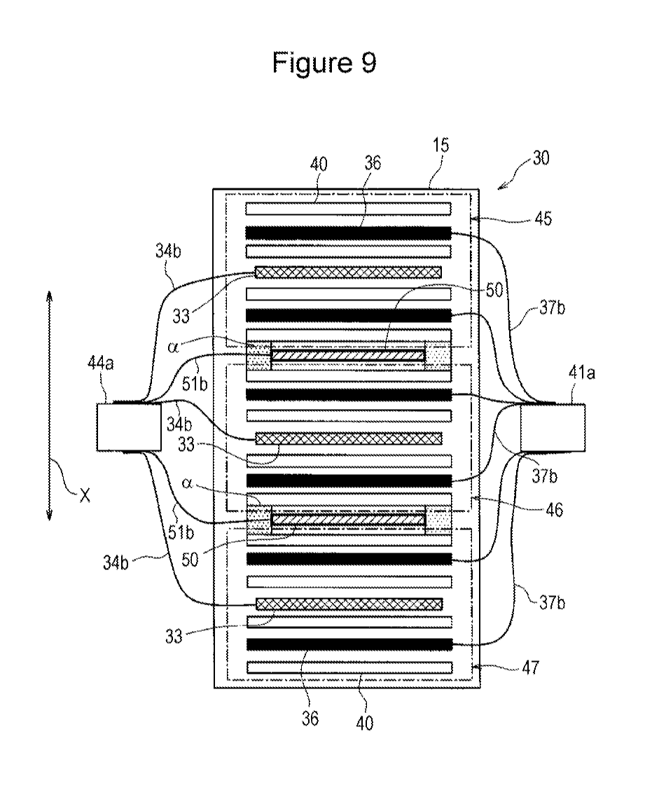

FIG. 9, corresponding to FIG. 2, illustrates another exemplary embodiment. FIG. 9 schematically illustrates a structure including, on both the right and left of the electrode unit 30, a connection portion of the positive electrode current collector 44a with the positive electrode tabs 34b and the intermediate positive electrode tab 51b, and a connection portion of the negative electrode current collector 41a with the negative electrode tabs 37b. FIG. 9 illustrates the positive electrode current collector 44a and the negative electrode current collector 41a on the outer sides of the electrode unit 30 in the lateral direction. However, the positive electrode current collector 44a and the negative electrode current collector 41a are actually arranged separately in the lateral direction of FIG. 9 above the electrode unit 30 (front side of the plane of FIG. 9).

The structure of FIG. 9 is different from the structure of FIGS. 1 to 5B in that it includes three electrode stacks stacked with intermediate positive electrode plates 50 interposed therebetween. For convenience of illustration, the three electrode stacks are described as a first electrode stack 45, a second electrode stack 46, and a third electrode stack 47, below. The positive electrode tabs 34b of the first electrode stack 45 and the second electrode stack 46, and the intermediate positive electrode tab 51b of the intermediate positive electrode plate 50 between the first electrode stack 45 and the second electrode stack 46 are collectively stacked on and welded to a first surface (upper surface in FIG. 9) of the positive electrode current collector 44a in the electrode stack direction X. Here, the positive electrode tabs 34b of the first electrode stack 45 and the positive electrode tabs 34b of the second electrode stack 46 may be spaced apart from each other in the lateral direction of FIG. 9, and separately stacked and welded to the positive electrode current collector 44a. The intermediate positive electrode tab 51b may be stacked on and welded to the positive electrode tabs 34b of the first electrode stack 45 or the positive electrode tabs 34b of the second electrode stack 46. The intermediate positive electrode tab 51b may be spaced apart from the positive electrode tabs 34b of the first electrode stack 45 and the second electrode stack 46 in the lateral direction of FIG. 9, and separately welded to the positive electrode current collector 44a.

The positive electrode tabs 34b of the third electrode stack 47 and the intermediate positive electrode tab 51b of the intermediate positive electrode plate 50 between the second electrode stack 46 and the third electrode stack 47 are collectively stacked on and welded to a second surface (lower surface in FIG. 9) of the positive electrode current collector 44a in the electrode stack direction X. Also in this case, the positive electrode tabs 34b and the intermediate positive electrode tab 51b may be spaced apart from each other in the lateral direction in FIG. 9, and separately welded to the positive electrode current collector 44a.

The negative electrode tabs 37b of the first electrode stack 45 and the second electrode stack 46 are collectively stacked on and welded to a first surface (upper surface of FIG. 9) of the negative electrode current collector 41a in the electrode stack direction X. The negative electrode tabs 37b of the third electrode stack 47 are collectively stacked on and welded to a second surface (lower surface of FIG. 9) of the negative electrode current collector 41a in the electrode stack direction X. Also in this case, the negative electrode tabs 37b of the first electrode stack 45 and the second electrode stack 46 may be spaced apart from each other in the lateral direction in FIG. 9, and separately welded to the negative electrode current collector 41a, as in the case of the positive electrode tabs 34b of the first electrode stack 45 and the second electrode stack 46.

In the structure of FIG. 9, the intermediate positive electrode plates 50 are disposed at two separate positions in the electrode stack direction X. This structure enables a large-sized and large-capacity secondary battery to have inter-separator holding areas a at two separate positions in the electrode stack direction X. This structure thus improves the performance in a long-term cycle and enhances the energy density. Other components and functions are same as those in the structure of FIGS. 1 to 5B or the structure of FIGS. 6 to 8. The secondary battery may include three or more electrode stacks.

Throughout the above embodiments, the case where the nonaqueous electrolyte is a liquid electrolytic solution is described. Instead, the nonaqueous electrolyte may be, for example, a gel polymer retaining a nonaqueous electrolyte. This structure also increases the amount of the retained nonaqueous electrolyte and improves the performance in a long-term cycle.

Throughout the above embodiments, the case where the exterior body is formed of a metal case is described. Instead, the exterior body may be a film exterior body formed by joining two laminate films together at the periphery to form a so-called pouched secondary battery.

### INDUSTRIAL APPLICABILITY

The present invention is usable as a stack-type nonaqueous electrolyte secondary battery.

### REFERENCE SIGNS LIST

10 stack-type nonaqueous electrolyte secondary battery (secondary battery)
12 case
13 case body
14 cover plate
14a through hole
15 holder
16 negative electrode terminal
17 positive electrode terminal
18a, 18b intermediate member
19 upper coupling member
20 insulating member
30 electrode unit
31, 32 electrode stack
33 positive electrode
33a positive electrode core
33b positive electrode composite layer
34a positive electrode plate body
34b positive electrode tab
35 tab stack
36 negative electrode
36a negative electrode core
36b negative electrode composite layer
37a negative electrode plate body
37b negative electrode tab
38 tab stack
40 separator
41, 41a negative electrode current collector
42 upper end plate portion
43 lower end plate portion
44, 44a positive electrode current collector
45 first electrode stack
46 second electrode stack
47 third electrode stack
50 intermediate positive electrode plate
50a intermediate positive electrode core
50b intermediate positive electrode composite layer
51a intermediate positive electrode plate body
51b intermediate positive electrode tab

1. A stack-type nonaqueous electrolyte secondary battery, comprising:
an electrode unit housed in an exterior body,
wherein the electrode unit includes a plurality of electrode stacks and an intermediate positive electrode plate,
wherein each of the electrode stacks includes a plurality of positive electrodes, a plurality of negative electrodes, and a plurality of separators disposed between the positive electrodes and the negative electrode and at both ends of the electrode stack,
wherein each of the positive electrodes includes a rectangular positive electrode plate body including a positive electrode composite layer, and a positive electrode tab extending from the positive electrode plate body,
wherein the intermediate positive electrode plate includes a rectangular intermediate positive electrode plate body including a positive electrode composite layer, and an intermediate positive electrode tab extending from the intermediate positive electrode plate body, one electrode stack of two of the electrode stacks has the negative electrode disposed adjacent to a first surface of the intermediate positive electrode plate with a corresponding one of the separators interposed therebetween, and the other electrode stack has the negative electrode disposed adjacent to a second surface of the intermediate positive electrode plate with a corresponding one of the separators interposed therebetween, and
wherein the intermediate positive electrode plate body has a smaller area on a side surface in a thickness direction than the positive electrode plate body of each of the electrode stacks.

2. The stack-type nonaqueous electrolyte secondary battery according to claim 1,
wherein the positive electrode tabs extending from end portions of the positive electrodes of at least two of the plurality of electrode stacks and the intermediate positive electrode tab extending from an end portion of the intermediate positive electrode plate between the two electrode stacks are collectively welded to a first surface of a positive electrode current collector electrically connected to a positive electrode terminal.

3. The stack-type nonaqueous electrolyte secondary battery according to claim 1,
wherein the positive electrode tabs extending from end portions of the positive electrodes of one electrode stack of at least two of the plurality of electrode stacks and the intermediate positive electrode tab extending from an end portion of the intermediate positive electrode plate between the two electrode stacks are collectively welded to a first surface of a positive electrode current collector electrically connected to a positive electrode terminal, and
wherein the positive electrode tabs extending from end portions of the positive electrodes of the other electrode stack of the two electrode stacks are collectively welded to a second surface of the positive electrode current collector.

4. The stack-type nonaqueous electrolyte secondary battery according to claim 1,
wherein, in the electrode unit formed by stacking the plurality of electrode stacks and the intermediate positive electrode plate, outermost electrodes of each electrode stack adjacent to the separators at both ends of the electrode stacks in a stack direction are the negative electrodes.
